(19) United States
(12) Patent Application Publication
(10) Pub. No.: US 2023/0033840 A1
(43) Pub. Date: Feb. 2, 2023

(54) FACE MASK STRAP RETENTION METHOD AND SYSTEM

(71) Applicant: Lighthouse Worldwide Solutions, Inc., Fremont, CA (US)

(72) Inventors: Peter Maguire, Medford, OR (US); Isaac Emilio Lopez, Medford, OR (US); Jason Peters, Jacksonville, OR (US)

(21) Appl. No.: 17/816,287

(22) Filed: Jul. 29, 2022

Related U.S. Application Data
(60) Provisional application No. 63/227,186, filed on Jul. 29, 2021.

(51) Int. Cl. A62B 18/08; A62B 18/02; A41D 13/11

(52) U.S. Cl. CPC A62B 18/08; A41D 13/1161; A62B 18/025

(57) ABSTRACT

A system and method for implementation of an improved weld pattern for the retention of straps to a face mask, configured to maintain maximum strength of the strap(s) without the use of glue or complete encapsulation via fabric welds. Proximal welds are positioned above and below ends of the straps without contacting the strap itself. The proximal welds are horizontal welds along the primary axis of the straps. The proximal welds are configured to reinforce primary vertical welds disposed along the very ends of the straps. A strip of weldable material is disposed atop the ends of the straps to facilitate the implementation of the horizontal and vertical welds.

### CONTINUITY

This application is a non-provisional patent application of provisional patent application number 63/227,186, filed on Jul. 29, 2021, and priority is claimed thereto.

### FIELD OF THE PRESENT INVENTION

The present invention relates to the field of personal protective equipment as used in the medical profession and others to prevent bacteria, viruses, dust, and debris from entering the respiratory system, and more specifically relates to a new form of face mask retention system and method configured to facilitate the permanent attachment of one or more straps to sides of a face mask without the use of adhesives and without compromising the material with which the strap is manufactured, ensuring an optimal fit without sacrificing strength of the strap.

### BACKGROUND OF THE PRESENT INVENTION

Face masks, conventionally a part of Personal Protective Equipment (PPE) are useful to prevent inhalation of dust, debris, viruses, bacteria, and similar contaminants. They also help to prevent the spread of contaminants from an infected individual. Generally, face masks are retained to the face of the wearer via one or more straps. The strap(s) are conventionally attached via an adhesive, stitching, welding, or staples.

Unfortunately, these methods of attachment require additional steps (such as stapling) during the manufacturing process of the face mask, often necessitating the use of separate machines. These additional steps (gluing, stapling, etc.) increase the cost of the face mask, lengthen the time of assembly of the face mask, and introduce potential points for manufacturing errors. Extended and repeated stretching of straps which are affixed by encapsulation via adhesive alone can lead to premature failure of the straps. If there were a way in which the straps could be affixed to the face mask without necessitating the use of adhesives or staples, let alone the use of a separate machine, the manufacturing process could be streamlined and expedited, and the durability and strength of the straps could be prolonged.

Some straps are composed of a thermoplastic elastomer, or polypropylene and natural rubber, which enables them to be affixed to the sides of the face mask via a fabric weld. However, straps composed of such materials lose strength when welded excessively, such as a complete encapsulation via weld. Conventionally in the industry, the entire end of the strap is covered with a weld pattern, and the strap is partially perforated to assist with strap retention. Unfortunately, when a weld pattern is placed over the entirety of the strap such as this, strength of the strap is reduced, and the strap is more prone to breakage. If there were a new weld pattern which minimized contact with the strap while reinforcing the containment of the strap ends to the mask with proximal (non-contacting) welds to the strap, strength of the straps could be increased, and breakage could be minimized.

Thus, there is a need for a new method and system by which straps are affixed to a face mask with a unique weld pattern. Such a system preferably employs a series of specifically placed fabric welds configured to surround and securely maintain the ends of the strap(s) in position at the sides of the mask without the use of any adhesive or staples. The system uses additional pieces of weldable material disposed atop the ends of the strap(s), enabling the partial encapsulation of the ends of the strap such that they are permanently held in position via friction.

### SUMMARY OF THE PRESENT INVENTION

The present invention is a system and method of strap retention configured to ensure that straps are affixed to sides of a face mask securely without the use of staples or adhesive. A strip, preferably composed of a polypropylene, is employed to provide for a series of fabric welds disposed around ends of the straps, securing the straps in position on the face mask via a friction fit.

The following brief and detailed descriptions of the drawings are provided to explain possible embodiments of the present invention but are not provided to limit the scope of the present invention as expressed herein this summary section.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The accompanying drawings, which are incorporated herein and form a part of the specification, illustrate the present invention and, together with the description, further serve to explain the principles of the invention and to enable a person skilled in the pertinent art to make and use the invention.

The present invention will be better understood with reference to the appended drawing sheets, wherein:

FIG. 1 exhibits an exploded view of the face mask strap retention system of the present invention as present on the face mask.

FIG. 2 depicts a view of the preferred embodiment of the face mask strap retention system of the present invention as shown from the side as installed on a face mask.

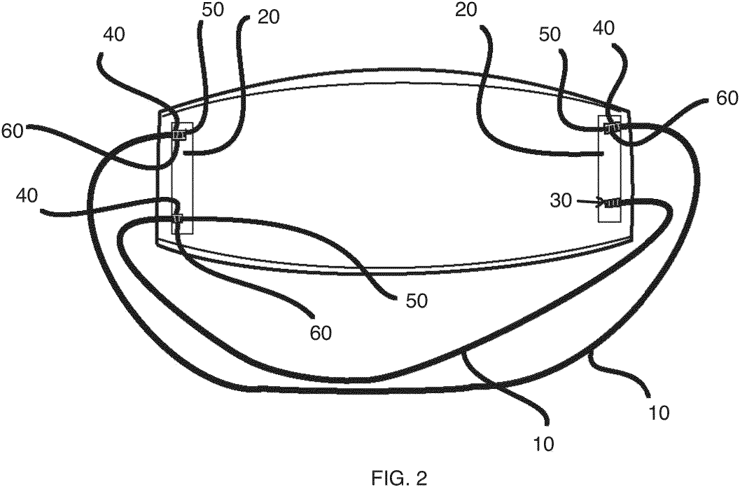

FIG. 3 shows a flow chart detailing the process of attachment of the strap(s) of the face mask via the system of the present invention.

FIG. 4 depicts the unique weld pattern of the present invention in isolation from a mask, straps, or the encapsulation strip.

FIG. 5 shows an image-based depiction of the front of a face mask equipped with the strap retention system and method of the present invention.

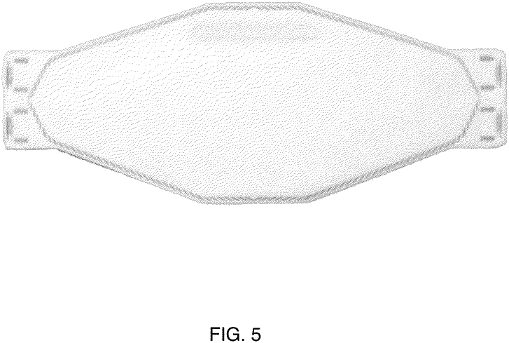

FIG. 6 shows an image-based depiction of the rear of a face mask equipped with the strap retention system and method of the present invention.

### DETAILED DESCRIPTION OF THE PREFERRED EMBODIMENT

The present specification discloses one or more embodiments that incorporate the features of the invention. The disclosed embodiment(s) merely exemplify the invention. The scope of the invention is not limited to the disclosed embodiment(s).

References in the specification to “one embodiment,” “an embodiment,” “an example embodiment,” etc., indicate that the embodiment described may include a particular feature, structure, or characteristic, but every embodiment may not necessarily include the particular feature, structure or characteristic. Moreover, such phrases are not necessarily referring to the same embodiment, Further, when a particular feature, structure, or characteristic is described in connection with an embodiment, it is submitted that it is within the knowledge of one skilled in the art to effect such feature, structure, or characteristic in connection with other embodiments whether or not explicitly described.

The present invention is a system and method of attaching one or more straps (10) to a face mask without the use of glue, staples, or stitching while increasing the elastic hold of the straps (10) to the face mask, thereby increasing the strength of the straps (10) of the face mask.

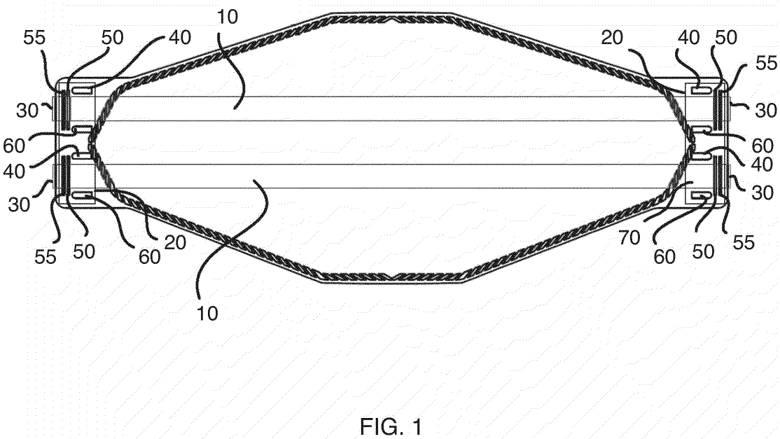

Critical to this increase in strength is a unique fabric weld pattern as exhibited in FIG. 1. A strip (20), as shown in FIG. 1, is disposed atop ends (30) of the strap(s) (10) and is secured in position via fabric welds: a top horizontal fabric weld (40), a first side vertical fabric weld (50), a second side vertical fabric weld (55), and a bottom horizontal fabric weld (60). Together, the top horizontal fabric weld (40), a side vertical fabric weld (50), and a bottom horizontal fabric weld (60) form a “U-shaped” channel (70) housing the end (30) of each strap (10). The U-shaped channel (70) exerts pressure on all sides of the ends (30) of the strap(s) (10), ensuring that the strap(s) (10) cannot be removed from the U-shaped channels (70) due to friction of the strap(s) (10) against the face mask and the strips (20).

In some embodiments of the present invention, it is envisioned that the top horizontal fabric weld (40) and bottom horizontal fabric weld (60) encroach upon the ends (30) of the strap(s) (10) slightly, helping to maximize the friction present between the three elements of the design. It should be noted that the side vertical fabric weld (50) is perpendicular to the top horizontal fabric weld (40) and bottom horizontal fabric weld (60). Likewise, it should be understood that the top horizontal fabric weld (40) and bottom horizontal fabric weld (60) are parallel. Minimizing encroachment of the fabric welds atop the strap(s) (10) helps to ensure that as much of the overall length of the strap (10) remains as intact as possible without perforating it, ensuring that the correct strength of the strap (10) is maintained. Strength of the straps (10) is ensured and maintained by not allowing the top horizontal fabric weld (40) and bottom horizontal fabric weld (60) to touch the straps (10) at all, but only the side vertical fabric welds (50, 55) contact the strap at the very ends of the straps (10). If the top horizontal fabric weld (40) and/or bottom horizontal fabric weld (60) came into contact with the straps (10), weak points are introduced into the elastic of the straps (10), causing the straps to break earlier (under less force).

It should be noted that the material of the strip (20) is carefully selected to be a heavier material in order to obtain optimal results. For example, heavier materials, in terms of grams per square meter (GSM), have been found to require more pounds of force to break or separate the strap (10) from the mask and strip (20) at the vertical fabric welds (50, 55). As the GSM of the strip (20) increases, so does the tensile force of the material.

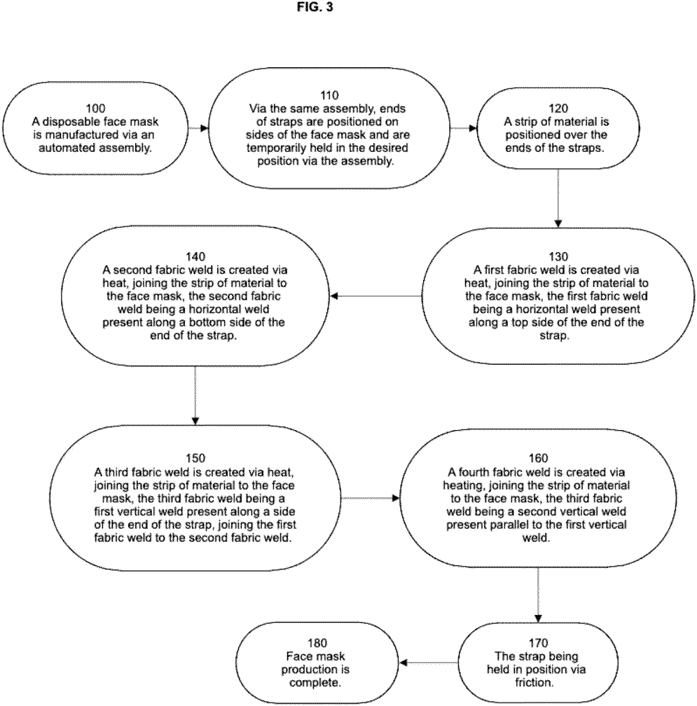

The method of use of the system of the present invention, as detailed in FIG. 3, is preferably as follows:
1. A disposable face mask is manufactured via an automated assembly. (100)
2. Via the same assembly, ends of straps are positioned on sides of the face mask and are temporarily held in the desired position via the assembly. (110)
3. A strip of material is positioned over the ends of the straps. (120)
4. A first fabric weld is created via heat, joining the strip of material to the face mask, the first fabric weld being a horizontal weld present along a top side of the end of the strap. (130)
5. A second fabric weld is created via heat, joining the strip of material to the face mask, the second fabric weld being a horizontal weld present along a bottom side of the end of the strap. (140)
6. A third fabric weld is created via heat, joining the strip of material to the face mask, the third fabric weld being a first vertical weld present along a side of the end of the strap, joining the first fabric weld to the second fabric weld. (150)
7. A fourth fabric weld is created via heat, joining the strip of material to the face mask, the third fabric weld being a second vertical weld present parallel to the first vertical weld. (160)
8. The strap being held in position via friction. (170)
9. Face mask production is complete. (180)

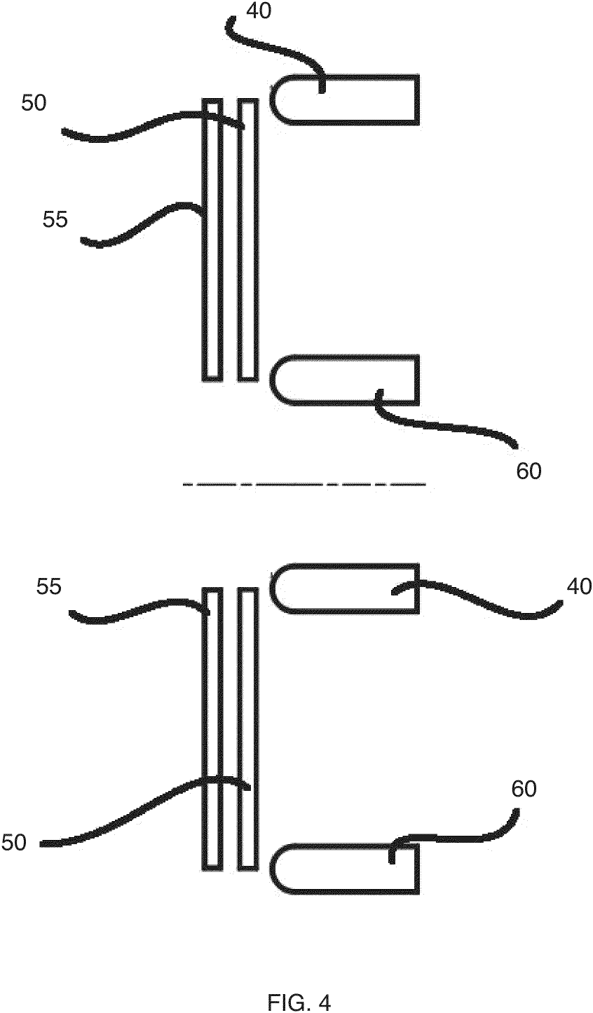

It should be noted that longer iterations of the side vertical fabric weld (50) provide the best retention of the straps (10) to the mask. Additionally, variance to the height of the top horizontal fabric weld (40) and bottom horizontal fabric weld (60) with respect to the side vertical fabric weld (50) is beneficial to the integrity of the strap retention. Staggering the welds, in addition to partial perforation of the ends of the straps help to facilitate the friction fit provided by the preferred embodiment of the present invention. For example, in some embodiments of the present invention, the side vertical fabric welds (50, 55) are 0.4 mm in height, and the top horizontal fabric welds (40) and bottom horizontal fabric welds (60) are 0.25 or 0.30 mm in height. The two side vertical fabric welds (50, 55) are preferably tapered approximately five degrees from the bottom as shown in FIG. 4. Further, it should be noted that each of the fabric welds are preferably created via heat, but could alternately be created via ultrasonic weld.

It should be noted that varying the height of the side vertical fabric welds (50, 55) helps to hold the strap better than having both side vertical fabric welds (50, 55) being of the same height. Additionally, it should be understood that the measurements cited above are optimized for a specific thickness and weight of strip (20) and straps (10), and are therefore subject to change if a different thickness of strap (10) is used. Further, it should be noted that a majority of the stresses enacted on the straps (10) when stretched is buffered and ultimately minimized due to the encapsulation layer enacted via the strip (20), as provided by the top horizontal fabric welds (40) and bottom horizontal fabric welds (60). This is effective as the only portion of the straps (10) which is directly touched by fabric welds is at the ends (30) of the straps (30), minimizing any compromise to the strength of the straps (30) by the welds.

To clarify the positioning of each fabric weld employed in the mask strap retention method of the present invention, refer to FIG. 1 and FIG. 4. It can be seen that there are two sets of fabric welds, a first set for a first side of the face mask to retain a first end of the at least one strap (10) to the face mask, and a second set for a second side of the face mask to retain a second end of the at least one strap (10) to the face mask. The first set mirrors the second set. In total, there are eight fabric welds in preferred embodiments of the present invention, four for the first set, and four for the second set. Additional sets are present for additional straps (10). Some embodiments of the present invention employ two straps (10), others may employ three straps (10), or one strap (10). It should be understood that, regardless of the number of straps employed, each strap has a first end and a second end, with each the first end of each strap configured to be attached to the first side of the face mask, and the second end of each strap configured to be attached to the second side of the face mask via the method of the present invention.

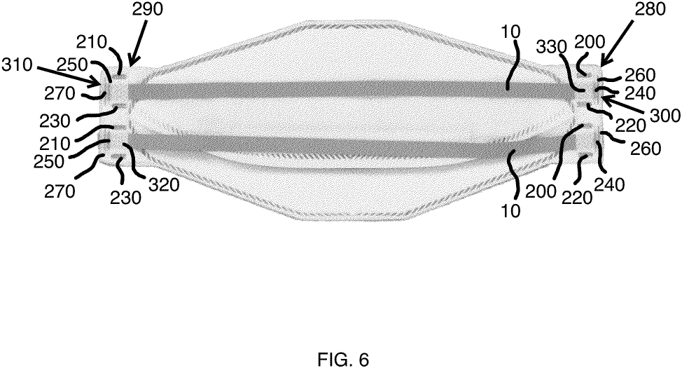

As shown in FIG. 6, each fabric weld is more clearly labeled in sequence of order of installation as reflected in the claims as filed. Therefore, the first fabric weld (200), second fabric weld (210), third fabric weld (220), fourth fabric weld (230), fifth fabric weld (240), sixth fabric weld (250), seventh fabric weld (260) and eighth fabric weld (270) as shown accordingly. The first side of the face mask (280) and second side of the face mask (290), as well as the first end (300) of the at least one strap (10) and second end (310) of the at least one strap (10) are shown. Further, the first strip of material (320) and second strip of material (330) are shown. Note that these components are identical to those previously described, but their labeling is clarified. It should be understood that the first side of the face mask (280) and second side of the face mask (290) mirror one another.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

We claim:

1. A method of retaining at least one strap to a face mask comprising:
positioning a first end of the at least one strap of a first side of the face mask;
positioning a second end of the at least one strap of a second side of the face mask;
temporarily holding the at least one strap in position;
placing a first strip of material over the first end of the at least one strap;
placing a second strip of material over the second end of the at least one strap;
creating a first fabric weld, joining the first strip of material to the first end of the face mask;
wherein the first fabric weld is a horizontal fabric weld present along a top side of the first end of the at least one strap;
creating a second fabric weld, joining the second strip of material to the second end of the face mask;
wherein the second fabric weld is a horizontal fabric weld present along a top side of the second end of the at least one strap;
creating a third fabric weld, joining the first strip of material to the first side of the face mask, the third fabric weld being a horizontal weld present along a bottom side of the first end of the strap;
creating a fourth fabric weld, joining the second strip of material to the second side of the face mask, the fourth fabric weld being a horizontal weld present along a bottom side of the second end of the strap;
creating a fifth fabric weld, joining the first strip of material to the first side of the face mask, the fifth fabric weld being a first vertical weld present along a side of the first end of the at least one strap, joining the first fabric weld to the third fabric weld;
creating a sixth fabric weld, joining the second strip of material to the second side of the face mask, the sixth fabric weld being a first vertical weld present along a side of the second end of the at least one strap, joining the second fabric weld to the fourth fabric weld;
creating a seventh fabric weld, joining the first strip of material to the first side of the face mask, the seventh fabric weld being a second vertical weld present parallel to the first vertical weld of the first side of the face mask; and creating an eighth fabric weld, joining the second strip of material to the second side of the face mask, the eighth fabric weld being a second vertical weld present parallel to the first vertical weld of the second side of the face mask.

2. The method of claim 1, wherein the first end of the at least one strap is held in position on the first side of the face mask by friction between the first strip of material, the first fabric weld, the third fabric weld, and the fifth fabric weld.

3. The method of claim 1, wherein the second end of the at least one strap is held in position on the second side of the face mask by friction between the second strip of material, the second fabric weld, the fourth fabric weld, and the sixth fabric weld.

4. The method of claim 1, wherein the first fabric weld, the third fabric weld, and the fifth fabric weld are disposed proximal to, but not in contact with, the first end of the at least one strap.

5. The method of claim 1, wherein the second fabric weld, the fourth fabric weld, and the sixth fabric weld are disposed proximal to, but not in contact with, the second end of the at least one strap.

6. The method of claim 1, wherein the seventh fabric weld is configured to reinforce the first strip of material as positioned against the first side of the face mask.

7. The method of claim 1, wherein the eighth fabric weld is configured to reinforce the second strip of material as positioned against the second side of the face mask.

8. The method of claim 1, further comprising:
perforating the first end of the at least one strap making the first end of the at least one strap coarse to increase friction between the first strip of material, the first end of the at least one strap, and the first end of the face mask; and
perforating the second end of the at least one strap, making the second end of the at least one strap coarse to increase friction between the second strip of material, the second end of the at least one strap, and the second end of the face mask.

9. A method of retaining at least one strap to a face mask comprising:
producing abrasion on a first end of at least one strap making a first end of the at least one strap coarse;
producing abrasion on a second end of the at least one strap, making the second end of the at least one strap coarse;
positioning the first end of the at least one strap of a first side of the face mask;
positioning the second end of the at least one strap of a second side of the face mask;
temporarily holding the at least one strap in position;
placing a first strip of material over the first end of the at least one strap;
placing a second strip of material over the second end of the at least one strap; creating a first fabric weld, joining the first strip of material to the first end of the face mask;
wherein the first fabric weld is a horizontal fabric weld present along a top side of the first end of the at least one strap;
creating a second fabric weld, joining the second strip of material to the second end of the face mask;
wherein the second fabric weld is a horizontal fabric weld present along a top side of the second end of the at least one strap;
creating a third fabric weld, joining the first strip of material to the first side of the face mask, the third fabric weld being a horizontal weld present along a bottom side of the first end of the strap;
creating a fourth fabric weld, joining the second strip of material to the second side of the face mask, the fourth fabric weld being a horizontal weld present along a bottom side of the second end of the strap;
creating a fifth fabric weld, joining the first strip of material to the first side of the face mask, the fifth fabric weld being a first vertical weld present along a side of the first end of the at least one strap, joining the first fabric weld to the third fabric weld;
creating a sixth fabric weld, joining the second strip of material to the second side of the face mask, the sixth fabric weld being a first vertical weld present along a side of the second end of the at least one strap, joining the second fabric weld to the fourth fabric weld;
creating a seventh fabric weld, joining the first strip of material to the first side of the face mask, the seventh fabric weld being a second vertical weld present parallel to the first vertical weld of the first side of the face mask; and creating an eighth fabric weld, joining the second strip of material to the second side of the face mask, the eighth fabric weld being a second vertical weld present parallel to the first vertical weld of the second side of the face mask.

10. The method of claim 9, wherein the fifth fabric weld partially overlaps the first end of the at least one strap.

11. The method of claim 9, wherein the sixth fabric weld partially overlaps the second end of the at least one strap.

12. The method of claim 10, wherein the sixth fabric weld partially overlaps the second end of the at least one strap.

13. The method of claim 2, wherein all fabric welds are created via heat.

14. The method of claim 2, wherein all fabric welds are created via ultrasonic welding.

15. A face mask apparatus comprising:
at least one strap, said at least one strap having a first end and a second end;
a first strip of material;
a second strip of material;
a first set of fabric welds, said first set of fabric welds disposed directly adjacent to said first end said at least one strap;
wherein said first set of fabric welds are disposed in communication with said first strip of material and the face mask;
a second set of fabric welds, said second set of fabric welds disposed directly adjacent to said second end of said at least one strap;
wherein said first set of fabric welds encapsulate said first end of said strap;
wherein said second set of fabric welds encapsulate said second end of said strap;
wherein friction between the face mask, the at least one strap, the first piece of material, and the first set of fabric welds maintains the first end of the at least one strap in position; and
wherein friction between the face mask, the at least one strap, the second piece of material, and the second set of fabric welds maintains the second end of the at least one strap in position.
